(19) United States
(12) Patent Application Publication
(10) Pub. No.: US 2012/0229785 A1
(43) Pub. Date: Sep. 13, 2012

(54) MULTILAYER MIRROR, LITHOGRAPIC APPARATUS, AND METHODS FOR MANUFACTURING A MULTILAYER MIRROR AND A PRODUCT

(75) Inventors: Vladimir Mihailovitch Krivtsun, Troitsk (RU); Andrei Mikhailovich Yakunin, Mierlo (NL); Viacheslav Medvedev, Moscow (RU)

(73) Assignee: ASML Netherlands B.V., Veldhoven (NL)

(21) Appl. No.: 13/510,505

(22) PCT Filed: Oct. 11, 2010
(86) PCT No.: PCT/EP10/65155

§ 371 Date: May 17, 2012

Related U.S. Application Data
(60) Provisional application No. 61/263,226, filed on Nov. 20, 2009.

(51) Int. Cl. G03B 27/70; G03B 27/32; F21V 9/06

(52) U.S. Cl. 355/66; 359/359; 355/77

(57) ABSTRACT

A multilayer mirror is configured to reflect extreme ultraviolet (EUV) radiation while absorbing a second radiation having a wavelength substantially-longer than that of the EUV radiation. The mirror includes a plurality of layer pairs stacked on a substrate. Each layer pair comprises a first layer that includes a first material, and a second layer that includes a second material. The first layer is modified to reduce its contribution to reflection of the second radiation, compared with a simple layer of the same metal having the same thickness. Modifications can include doping with a third material in or around the metal layer to reduce its electric conductivity by chemical bonding or electron trapping, and/or splitting the metal layer into sub-layers with insulating layers. The number of layers in the stack is larger than known multilayer mirrors and may be tuned to achieve a minimum in IR reflection.

### CROSS-REFERENCE TO RELATED APPLICATIONS

This application claims the benefit of U.S. provisional application 61/263,226, which was filed on Nov. 20, 2009, and which is incorporated herein in its entirety by reference.

### FIELD

The present invention relates to multilayer mirrors, generally reflective optical elements, for reflecting extreme ultraviolet (EUV) radiation. The invention further relates to lithographic apparatus including such a minor, methods for manufacturing multilayer mirrors and methods of manufacturing products by EUV lithography.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of one or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at one time, and scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

A key factor limiting pattern printing is the wavelength λ of the radiation used. In order to be able to project ever smaller structures onto substrates, it has been proposed to use extreme ultraviolet (EUV) radiation which is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such EUV radiation is sometimes termed soft x-ray. Possible sources include, for example, laser-produced plasma sources, discharge plasma sources, or synchrotron radiation from electron storage rings.

Optical elements in a projection system for EUV radiation are generally reflective in nature—curved mirrors—because materials which could transmit EUV radiation with refraction are not readily available. Even for a reflective optical element, mirrors EUV radiation at normal incidence are also relatively complex, multilayer structures. Examples of multilayer mirrors (MLMs) are described, for example, in DE 10155711 A1 (Fraunhofer Institute). A practical, though far from ideal, mirror can be constructed by interleaving pairs of metal (typically molybdenum (Mo)) and non-metal (typically silicon (Si)) layers. By controlling the ratio of thickness between the two layers in each layer pair, controlling the overall thickness of each layer pair, and by stacking several tens of layers on top of one another, reflectivities on the order of 60-70% may be achieved.

EUV sources based on a Sn plasma do not only emit the desired in-band EUV radiation but also out-of-band radiation, most notably in the deep UV (DUV) range (100-400 nm). Moreover, in the case of Laser Produced Plasma (LPP) EUV sources, the infrared radiation from the laser, usually at 10.6 μm, may present a significant amount of unwanted radiation. Since the optics of the EUV lithographic system generally have substantial reflectivity at these wavelengths, the unwanted radiation may propagate into the lithography tool with significant power if no measures are taken.

In a lithographic apparatus, out-of-band radiation should be minimized for several reasons. Firstly, resist is sensitive to out-of-band wavelengths, and thus the image quality may be deteriorated. Secondly, unwanted radiation, especially the 10.6 μm radiation in LPP sources, leads to unwanted heating of the mask, wafer and optics. In order to bring unwanted radiation within specified limits, spectral purity filters (SPFs) are being developed. The design and manufacture of SPFs is challenging and full of compromise. Known filters currently attenuate the wanted EUV radiation undesirably, while also passing a significant minority of the unwanted radiation. The filters are also very expensive to manufacture.

The inventors have turned their attention to the design of the reflecting (MLM) surfaces, which conventionally reflect a significant fraction of the unwanted radiation: sometimes a higher fraction than is reflected of the wanted EUV radiation. There are options for modifying an MLM structure to attenuate out-of-band radiation. The proposals in that case are to add a multilayer structure on top of the EUV-reflecting structure, for attenuating the unwanted wavelengths. Moreover, the range of wavelengths discussed as unwanted may be limited to UV and visible wavelengths, that is shorter than 1 μm and far shorter than the 10.6 μm and similar wavelengths addressed in the present case.

The inventors have studied the mechanisms of reflection of the different wavelengths of interest and have recognized that a multilayer mirror (MLM) containing metal layers can be modified so that the metal layers are inherently less reflective for long wavelength radiation like that of the CO₂ laser (especially 10.6 μm). Since reflectivity of the metals in the IR range is caused by presence of free conducting electrons in metal, the inventors have considered whether suppression of IR reflection can be achieved by modification of the electronic properties of the metallic layers. Example techniques for this purpose include depletion of metal layers with conducing electrons or restricting effective number of electrons due to so called dimensional anomalous skin-effect.

The inventors moreover have studied further the influence of the overall stack height (number of layer pairs) on the relative reflectivity in EUV and IR wavelengths.

### SUMMARY

According to an aspect of the invention, there is provided a multilayer mirror configured to reflect extreme ultraviolet (EUV) radiation while absorbing radiation of a second type having a wavelength substantially longer than that of the EUV radiation, the mirror comprising a plurality of layer pairs stacked on a substrate, each layer pair comprising a first layer comprising at least a first material and a second layer comprising at least a second material, wherein the first layer in at least a subset of the layer pairs is modified to reduce its contribution to reflection of said second radiation, compared with a simple layer of the first material having the same thickness.

Embodiments of the invention include layers of the first type modified in their conductivity by the presence of a third material. Embodiments of the invention include sub-divided layers of the first material, separated by layers of a fourth material acting as an insulator.

Embodiments of the invention may include a relatively large number of such layer pairs, compared with conventional MLM structures. In some embodiments, the number of layer pairs in said subset is greater than 80, for example 80-150, and for example greater than 90.

A thickness of each of the sub-layers may be less than 2 nm, even less than 1 nm. Optionally, the number of sub-layers in at least a subset of the modified first layers may be 2 or 3. Preferably, the first material is Mo and the second material is Si.

According to an aspect of the invention, there is provided a multilayer mirror configured to reflect extreme ultraviolet (EUV) radiation while absorbing radiation of a second type having a wavelength substantially longer than that of the EUV radiation, the mirror comprising a plurality of layer pairs stacked on a substrate, each layer pair comprising a first layer comprising a first material and a second of layer comprising a second material, wherein the number of layer pairs in said stack is greater than 80, for example 80-150, and for example greater than 90.

The total thickness of the plurality of layer pairs may be greater than 500 nm. The stack may be formed on top of a substrate layer comprising a layer of the first material or a material having similar properties, and wherein the layer o f the first material in the substrate layer is five or more times thicker than the first layer. Optionally, the first material is a metal, such as Mo, and the second material is a semiconductor, such as Si. The thickness of each layer pair in a substantial portion of the stack may be in the range 5-7 nm or even 6.5-7 nm.

According to an aspect of the invention, there is provided a lithographic apparatus comprising a radiation source configured to generate radiation comprising extreme ultraviolet radiation; an illumination system configured to condition the radiation into a beam of radiation; a support configured to support a patterning device, the patterning device being configured to pattern the beam of radiation; and a projection system configured to project a patterned beam of radiation onto a target material; wherein at least one of said radiation source, said illumination system and said projection system includes a multilayer mirror according to the first or second aspect of the invention, as set forth above.

The radiation source may comprise a fuel delivery system and laser radiation source, the laser radiation source being arranged to deliver radiation at infrared wavelength onto a target comprising plasma fuel material delivered by said fuel delivery system for the generation of said extreme ultraviolet radiation, the radiation source thereby emitting a mixture of extreme ultraviolet (EUV) and infrared radiation toward said multilayer mirror, the multilayer mirror having a reflectivity greater than 60% for said EUV radiation and having reflectivity less than 40% for said infrared radiation. The multilayer mirror may have a reflectivity less than 10%, or even less than 5% for said infrared radiation.

According to an aspect of the invention, there is provided a method for manufacturing a multilayer mirror configured to transmit extreme ultraviolet radiation, the method comprising: depositing alternately first and second types of layers to form a stack of layer pairs on a substrate, wherein each layer pair comprises a first layer comprising at least a first material and a second layer comprising at least a second material, and wherein the first layer in at least a subset of the layer pairs is formed so as to reduce its contribution to reflection of said second radiation, compared with a simple layer of the first material having the same thickness. The number of layer pairs in said stack may be greater than 80, for example 80-150, and for example greater than 90.

According to an aspect of the invention, there is provided a method of manufacturing a multilayer mirror wherein the stack is formed according to the method of manufacturing a multilayer mirror as set forth above.

According to an aspect of the invention, there is provided a method for manufacturing a product by lithography, comprising the steps of illuminating a patterning device with EUV radiation from an EUV radiation source via an illumination system and projecting an image of said patterning device onto a substrate by projection of said EUV radiation via a projection system, wherein at least one of said illumination system or said projection system comprises an optical element including a multilayer mirror in accordance with the first or second aspect of the invention, as set forth above.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts schematically a lithographic apparatus according to an embodiment of the invention;

FIG. 2 depicts the layout of a practical lithographic apparatus according to an embodiment of the invention;

FIG. 3 illustrates the general structure and parameters of a multilayer mirror (MLM) for use in the apparatus of FIG. 2 or for other purposes;

FIGS. 4a and 4b illustrate calculated performances of a hypothetical multilayer minor having layer pairs of conventional form;

FIG. 5 illustrates part of a multilayer minor, modified in accordance with an embodiment of the invention;

FIG. 6 illustrates a calculated performance for the modified multilayer mirror of FIG. 5 in contrast with a conventional structure;

FIG. 7 illustrates part of a multilayer mirror structure modified in different forms of an embodiment of the invention;

FIGS. 8a and 8b illustrate calculated performances for two example minors according to a first variant within the embodiment shown in FIG. 7; and

FIGS. 9a and 9b illustrate calculated performances for two example minors according to a second variant within the embodiment shown in FIG. 7.

### DETAILED DESCRIPTION

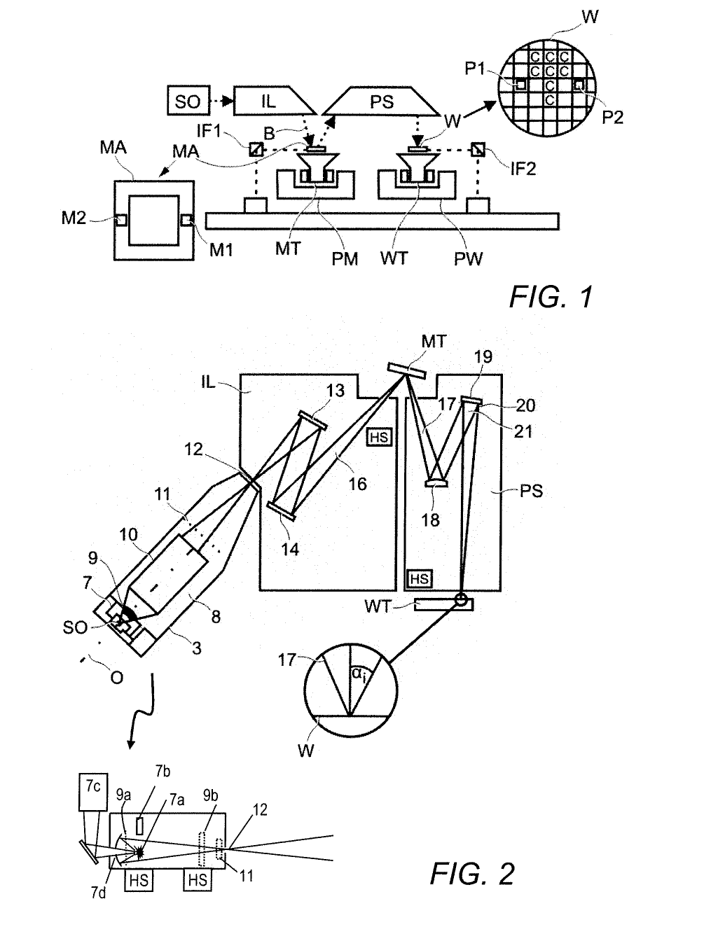

FIG. 1 depicts schematically the main features of a lithographic apparatus according to an embodiment of the invention. The apparatus includes a radiation source SO and an illumination system (illuminator) IL configured to condition a radiation beam B (e.g. UV radiation or EUV radiation) from the source. A support MT (e.g. a mask table) is configured to support a patterning device MA (e.g. a mask or a reticle) and is connected to a first positioner PM configured to accurately position the patterning device in accordance with certain parameters. A substrate table (e.g. a wafer table) WT is configured to hold a substrate W (e.g. a resist-coated semiconductor wafer) and is connected to a second positioner PW configured to accurately position the substrate in accordance with certain parameters. A projection system PS is configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The support MT supports the patterning device. It holds the patterning device in a manner that depends on the orientation of the patterning device, the design of the lithographic apparatus, and other conditions, for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system.

The term “patterning device” used herein should be broadly interpreted as referring to any device that can be used to impart a radiation beam with a pattern in its cross-section such as to create a pattern in a target portion of the substrate. Generally, the pattern imparted to the radiation beam will correspond to a particular functional layer in a device being created in the target portion, such as an integrated circuit. It should be noted that the pattern imparted to the radiation beam may not exactly correspond to the desired pattern in the target portion of the substrate, for example if the pattern includes phase-shifting features or so called assist features.

The patterning device may be transmissive or reflective. For practical reasons, current proposals for EUV lithography employ reflective patterning devices, as shown in FIG. 1. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of a vacuum. It may be desired to use a vacuum for EUV or electron beam radiation since other gases may absorb too much radiation or electrons. A vacuum environment may therefore be provided to the whole beam path with the aid of a vacuum wall and vacuum pumps. An example specific to EUV is described below, with reference to FIG. 2.

Any use of the term “projection lens” herein may be considered as synonymous with the more general term “projection system”. For EUV wavelengths, transmissive materials are not readily available. Therefore “lenses” for illumination and projection in an EUV system will generally be of the reflective type, that is to say, curved mirrors.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system Immersion techniques are well known in the art for increasing the numerical aperture of projection systems. The term “immersion” as used herein does not mean that a structure, such as a substrate, must be submerged in liquid, but rather only means that liquid is located, for example, between the projection system and the substrate during exposure.

Referring to FIG. 1, the illuminator IL receives radiation from radiation source SO. The source and the lithographic apparatus may be separate entities, for example when the source is an excimer laser. In such cases, the source is not considered to form part of the lithographic apparatus and the radiation is passed from the source SO to the illuminator IL with the aid of a beam delivery system (not shown) including, for example, suitable directing mirrors and/or a beam expander. In other cases the source may be an integral part of the lithographic apparatus. The source SO and the illuminator IL, together with the beam delivery system if required, may be referred to as a radiation system.

The illuminator IL may include an adjusting device (adjuster) configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator and a condenser. The illuminator may be used to condition the radiation beam, to have a desired uniformity and intensity distribution in its cross-section.

The radiation beam B is incident on the patterning device MA, which is held on the support MT, and is patterned by the patterning device. After being reflected from the patterning device MA, the radiation beam B passes through the projection system PS, which focuses the beam onto a target portion C of the substrate W. With the aid of the second positioner PW and a position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 (which may also be an interferometric device, linear encoder or capacitive sensor) can be used to accurately position the patterning device MA with respect to the path of the radiation beam B, e.g. after mechanical retrieval from a mask library, or during a scan.

In general, movement of the mask support MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper, as opposed to a scanner, the support MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, a programmable patterning device MA is kept essentially stationary, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be referred to as “maskless lithography” that utilizes programmable patterning device, such as a programmable mirror array of a type as referred to above.

Combinations and/or variations on the above described modes of use or entirely different modes of use may also be employed.

FIG. 2 shows a schematic side view of a practical EUV lithographic apparatus. It will be noted that, although the physical arrangement is different to that of the apparatus shown in FIG. 1, the principle of operation is similar. The apparatus includes a source-collector-module or radiation unit 3, an illumination system IL and a projection system PS. Radiation unit 3 is provided with a radiation source SO which may employ a gas or vapor, such as for example Xe gas or a vapor of Li, Gd or Sn in which a very hot discharge plasma is created so as to emit radiation in the EUV range of the electromagnetic radiation spectrum. The discharge plasma is created by causing a partially ionized plasma of an electrical discharge to collapse onto the optical axis O. Partial pressures of, for example, 10 Pa 0.1 m bar of Xe, Li, Gd, Sn vapor or any other suitable gas or vapor may be required for efficient generation of the radiation. In an embodiment, a Sn source as EUV source is applied.

For this type of source, an example is the LPP source in which a CO₂ or other laser is directed and focused in a fuel ignition region. Some detail of this type of source is shown schematically in the lower left portion of the drawing. Ignition region 7a is supplied with plasma fuel, for example droplets of molten Sn, from a fuel delivery system 7b. The laser beam generator 7c may be a CO₂ laser having an infrared wavelength, for example 10.6 micrometer or 9.4 micrometer. Alternatively, other suitable lasers may be used, for example having respective wavelengths in the range of 1-11 micrometers. Upon interaction with the laser beam, the fuel droplets are transferred into plasma state which may emit, for example, 6.7 nm radiation, or any other EUV radiation selected from the range of 5-20 nm. EUV is the example of concern here, though a different type of radiation may be generated in other applications. The radiation generated in the plasma is gathered by an elliptical or other suitable collector 7d to generate the source radiation beam 7e.

The radiation emitted by radiation source SO is passed from the source chamber 7 into collector chamber 8 via a contaminant trap 9 in the form of a gas barrier or “foil trap”. This will be described further below. Returning to the main part of FIG. 2, collector chamber 8 may include a radiation collector 10 which is, for example, a grazing incidence collector comprising a nested array of so-called grazing incidence reflectors. Radiation collectors suitable for this purpose are known from the prior art. Alternatively, the apparatus can include a normal incidence collector for collecting the radiation. The beam of EUV radiation emanating from the collector 10 will have a certain angular spread, perhaps as much as 10 degrees either side of optical axis O.

Radiation passed by collector 10 transmits through a spectral purity filter 11. In contrast to reflective grating spectral purity filters, the transmissive spectral purity filter 11 does not change the direction of the radiation beam. Reflective filters are possible as an alternative, however.

The radiation is focused in a virtual source point 12 (i.e. an intermediate focus) from an aperture in the collection chamber 8. From chamber 8, the radiation beam 16 is reflected in illumination system IL via normal incidence reflectors 13,14 onto a reticle or mask positioned on reticle or mask table MT. A patterned beam 17 is formed which is imaged by projection system PS via reflective elements 18,19 onto wafer W mounted wafer stage or substrate table WT. More elements than shown may generally be present in the illumination system IL and projection system PS. One of the reflective elements 19 has in front of it an NA disc 20 having an aperture 21 there-through. The size of the aperture 21 determines the angle subtended by the patterned radiation beam 17 as it strikes the substrate table WT.

FIG. 2 shows the spectral purity filter 11 positioned downstream of the collector 10 and upstream of the virtual source point 12. In alternative embodiments, not shown, the spectral purity filter 11 may be positioned at the virtual source point 12 or at any point between the collector 10 and the virtual source point 12. The filter 11 ideally would pass all of the wanted EUV radiation and none of the unwanted (DUV, IR) radiation. In practice, of course, performance in these parameters is not perfect. The practical SPF will attenuate the wanted radiation somewhat and allow some of the unwanted radiation through. Embodiments of the invention provides an alternative approach to reducing the unwanted radiation while keeping as much as possible of the wanted EUV radiation. Embodiments of the invention can be applied at any of the reflective elements, including mirrors 13, 14, 18 and 19, and/or collector 10. Depending on its performance in eliminating unwanted radiation emerging from, for example, the collector 10, spectral purity filter 11 might in principle be omitted entirely. Alternatively, the novel reflector and a spectral purity filter may both be used, at selected points in the system. By reducing the amount of heating at the filter, for example, a collector employing the novel principles disclosed herein may relax design constraints in the filter, allowing its EUV-passing performance to be improved.

The gas barrier includes a channel structure such as, for instance, described in detail in U.S. Pat. No. 6,614,505 and U.S. Pat. No. 6,359,969, which are incorporated herein by reference. The purpose of this contaminant trap is to prevent or at least reduce the incidence of fuel material or by-products impinging on the elements of the optical system and degrading their performance over time. These elements include the collector 10, and also the collector. In the case of the LPP source shown in detail at bottom left, the contaminant trap includes a first trap arrangement 9a which protects the elliptical collector 7d, and optionally a further trap arrangements such as shown at 9b. The gas barrier may act as a physical barrier (by fluid counter-flow), by chemical interaction with contaminants and/or by electrostatic or electromagnetic deflection of charged particles

### Multilayer Mirror Examples

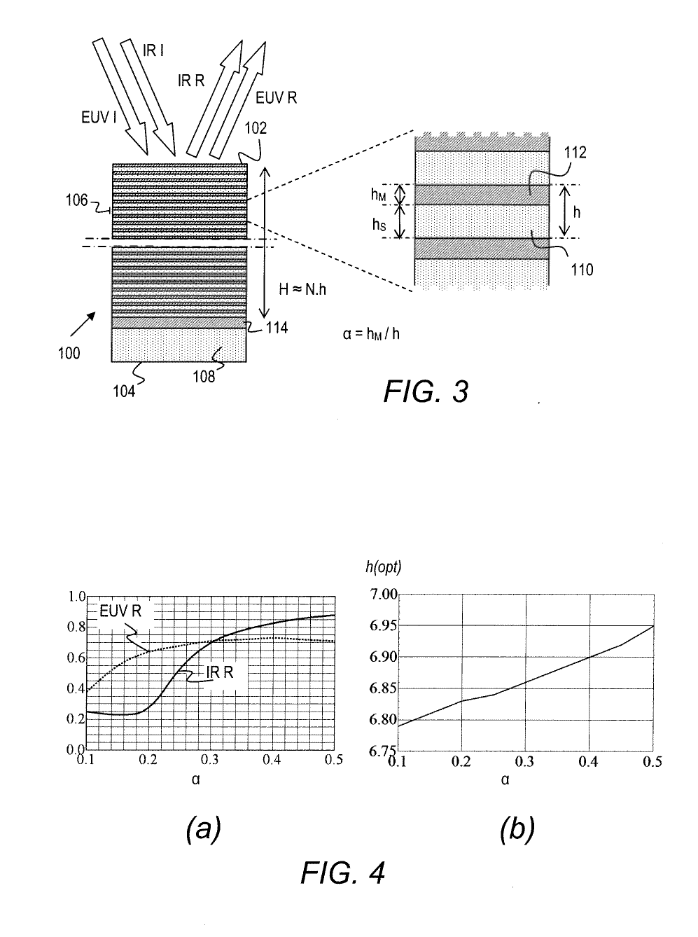

FIG. 3 illustrates the basic structure of a multilayer mirror (MLM) reflecting element 100. This may be used as any of the reflecting elements in the lithographic apparatus described above. It may also be used a reflective element in any other EUV system where infra-red radiation is to be attenuated. Furthermore, the principles described may be adapted to other combinations of wanted and unwanted wavelengths, where the same physical principles apply. For the purposes of illustration, the mirrors illustrated will be planar, and very much exaggerated in thickness, compared with their area. In practical applications, planar reflectors, curved (concave/convex) reflectors and/or multi-faceted reflectors may be wanted, and the term “mirror” is used for simplicity herein, to include all such reflecting elements.

MLM 100 has a front surface 102, and a rear surface 104. Incident radiation EUV I and IR I impinges on the front surface 102 at an angle of incidence, which may be normal to the surface 102, may be oblique to surface 102, or may be a mixture of a range of incidence angles, as is well known. By one or more mechanisms of interaction with the material of mirror 100, portions of the incident radiation are re-emitted as reflected radiation EUV R and IR R, as illustrated.

The structure of mirror 100 comprises a stack of layered pairs 106, arranged on a substrate 108. Within each layered pair, a layer 110 of a first material is topped by a layer 112 of second material. For the purposes of explanation, these will be referred to as the non-metallic or silicon (Si) layer 110 and the metal or molybdenum (Mo) layer 112. These materials are commonly selected for EUV mirrors for the applications currently envisaged. Methods of their manufacture are well known, comprising various techniques for deposition of precisely-controlled thickness and uniformity. Other materials may be selected according to the application and the environment. The references to Mo and Si layers in the examples described herein is purely for the sake of example, and for ease of understanding.

Also shown in FIG. 3 are various parameters useful in the discussion and characterization of different MLM structures. The height of one layered pair, which will be referred to also as the period of the periodic structure forming the stack, is labelled h, typically expressed in nanometers. Within the layer pair, h_{M} is the height of the metal layer 112, while hₛ is the height of the non-metallic layer 110. A parameter α (alpha) is defined as the ratio of the metal layer thickness to the period h. The overall height H of the structure is determined naturally by the height h of a layer pair and the number N of layered pairs in the stack. For the purposes of this discussion, the layered pairs 106 are all assumed to be identical. As discussed in the prior art documents mentioned in the introduction, however, there can be particular benefits in varying the composition of the layered pair either vertically (normal to the front surface) or across the area of the minor. These benefits include, for example, improving the uniformity of reflection intensities under variations in wavelength, incidence angle and the like. These techniques, which will not be discussed further in detail herein, can all be applied in combination with the novel layer structures to be described, to obtain the aforementioned benefits.

Also illustrated is the possibility for the rearmost metal layer 114 to be thicker than the ‘normal’ layers. Front surface 102 may also have particular construction, for example protective coatings, rather than being identical to the other periods within the stack. Also, within each period, it will be seen that additional layers and split layers may be employed in the novel MLM device, and the term ‘layer pair’ is intended to cover the general periodic unit, rather than strictly two layers.

### Example of MLM (Calculated)

As a reference case for discussion of the modifications to be made in accordance with the invention, calculations were made for Mo/Si multilayer minor of normal incidence with number of periods N=400. The calculation is based on the Drude formula dielectric permittivity, shown further below as formula (1).

On FIG. 4(a) there are presented plots for in-band EUV reflection coefficient (dotted line) and IR reflection coefficient (solid line) depending on relative Mo content a. EUV reflection was optimized with respect of period h for given α. Dependence of optimal period (α value yielding maximum EUV R) is given on FIG. 4(b). The same results are tabulated here in Table 1.

TABLE 1

| α | h, nm | N | EUV R | IR R |
|---|---|---|---|---|
| 0.10 | 6.79 | 400 | 0.38 | 0.25 |
| 0.15 | 6.81 | 400 | 0.55 | 0.23 |
| 0.20 | 6.83 | 400 | 0.64 | 0.28 |
| 0.25 | 6.84 | 400 | 0.68 | 0.53 |
| 0.30 | 6.86 | 400 | 0.71 | 0.70 |
| 0.35 | 6.88 | 400 | 0.72 | 0.78 |
| 0.40 | 6.90 | 400 | 0.73 | 0.83 |
| 0.45 | 6.92 | 400 | 0.72 | 0.86 |
| 0.50 | 6.95 | 400 | 0.71 | 0.88 |

It may be noted that the number of periods in this stack is very high (N=400) compared with conventional examples (N=30-60). This is not to indicate that 400 is a likely number of layers in a practical embodiment, but it does eliminate from the reference case interference from the rear surfaces and layers of the mirror. These effects will be discussed separately later. As can be seen, the EUV reflectivity of the stack never approaches the ideal figure of unity, but rises significantly as a rises, saturating (flattening off) at just over 70%. Unfortunately, there is a trade-off, in that IR reflectivity, initially relatively low (but far from zero), raises to match and then exceed EUV R as α passes 0.3. This is the observed behavior of practical EUV mirrors, and places great demands on the mirrors and also on the spectral purity filters up- and downstream of the mirrors, if the heating and imaging problems discussed above are to be minimized or even avoided.

The present application describes a number of measures that can be taken, singly or in combination, to produce a modified multilayer mirror (MLM) that is still reasonably reflective for in-band radiation (EUV), while being far less reflective for long wavelength IR radiation like that of CO₂ laser (especially 10.6 μm). Since reflectivity of the metals in IR range is caused by presence of free conducting electrons in metal, the inventors have recognized that suppression of IR reflection could be achieved by modification of the electronic properties of the metallic layers. Different techniques will be described, such as depletion of metal layers with conducing electrons or restricting the effective number of electrons due to so called dimensional anomalous skin-effect.

Another novel feature of the proposed MLM is in the large number of layer pairs in the stack. Conventionally, an optimum number N of pairs is found to be in the tens, say 30-60 pairs, for the reason that EUV reflectivity does not tend to increase with N beyond those kinds of values. The inventors have calculated, however, that increasing the number of layers significantly allows the deployment of techniques that reveal further optimum values for N, in which particularly the long IR radiation is suppressed, not reflected. One mechanism why this occurs may be destructive interference between IR waves reflected from front portions and rear portions of the stack, somewhat in the manner of a ‘quarter wave’ antireflection coating. These measures will be discussed further below.

The first type of modification (modified metal layer properties) can be applied on its own or in combination with the second type (stack height), and vice versa. While the inventors endeavor to provide theoretical basis for each improvement, the invention in each this and other aspects is not limited by any particular theory or mechanism. When the two techniques are combined, the effects can be greater than the sum of their individual contributions. For example, with the modified metal layers the IR radiation can penetrate a larger number of layer pairs than in known structures, which contributes to its absorption deeper in the stack, and also to its ability to take part in destructive interference between portions reflected from front and rear parts of the stack.

### Anomalous Skin-Effect Background

Optical properties of metals are described by interaction between electromagnetic waves and the ‘electron gas’ in the metal. A wave incident on a metal surface (such as surface 102 or any of the metal surfaces within the stack) induces current. The main part of energy transferred from field to moving electrons is irradiated in the form of secondary waves which produce reflected and transmitted waves. Another part of this energy is transferred from electrons to ionic lattice due to scattering of electrons on phonons and impurities. Those two mechanisms cause attenuation of the electromagnetic wave in metal. Attenuation length δ is often called skin depth (for Mo=35 nm @ 10.6 μm). Penetration of electromagnetic field in a thin surface region in metal is called skin-effect. Optical properties of metals depend significantly on the ratio of skin depth δ and mean free path L of electrons. The case when δ>>L is so called normal skin-effect (microwave region). In the infrared region, attenuation length strongly decreases and at a definite moment becomes less than the mean free path L. This is the so-called anomalous skin-effect. Such conditions reduce the number of electrons participating in conductivity. Notably the number reduces in proportion to δ/L. This effect becomes more remarkable in thin films when its thickness d is less than skin depth. Under this condition (d<δ), the effective number of conduction electrons decreases even more strongly. Optical properties of metal films in the IR region tend to be strongly dependent on film thickness. Films with such properties are more transparent than those with optical properties of bulk metal. EUV properties of films do not depend on the thickness, because the mechanism of interaction of EUV radiation sufficiently differs from that in the IR region.

The above observation allows for the reduction of the reflection coefficient in long-wavelength region of multilayer mirror, preserving high EUV reflectivity. When decreasing thickness (d=h_{M}) of metal layers, infrared radiation penetrates sufficiently deeper in the MLM, but simultaneously it is absorbed by larger number of metallic layers and/or reaches bulk substrate 108 of the multilayer. Thus there is a possibility to differ fractional content of metal and dielectric in MLM so that reflectivity in IR will be remarkably diminished. The fractional content of metal and dielectric in MLM is described by the ratio (α) of metallic layer thickness d to period thickness h.

In order to estimate the range of a and h where EUV reflection and IR suppression are optimized we suggest simple model describing optical properties of metal films. The model is based on modification of the Drude formula (1) for dielectric permittivity for conditions (d<δ).

$$ɛ ( ω , d ) = P + ( {ɛ}_{1} ( ω ) - P ) β \frac{d}{δ} + i {ɛ}_{2} ( ω ) β \frac{d}{δ} \qquad ( 1 )$$

where P is the residual dielectric constant, ε₁(ω) and ε₂(ω) are real and imaginary parts of bulk dielectric function at angular frequency ω.

### Reduction of Conductivity Due to Chemical Bonding or Electron Trapping

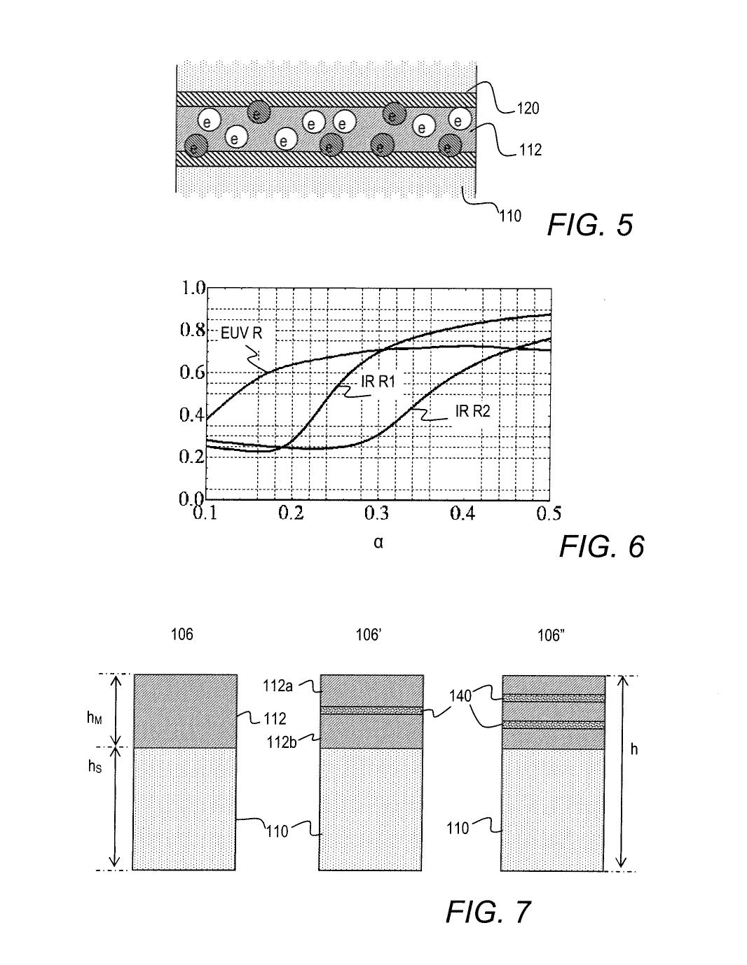

FIG. 5 illustrates the modification according to a first approach. If a metal layer 112 is surrounded with a material 120 forming chemical bonds with the metal Mo, or containing low acceptor energy levels, then this environment will disable a proportion of the conduction electrons from Mo layer (free conduction electrons are shown schematically as white circles in FIG. 5, the trapped ones as shaded circles). Considering that Mo layers are very thin, the portion of conducting electrons taken by chemical bonds could be large enough. That results in reduction of metal permittivity.

As an example, atoms of iron (Fe) may provide suitable ‘deep centers’, able to trap free electrons from the Mo or other metal layer. These trap sites can be deployed by modifying the composition only at the interface between the Si and Mo layers, so as to minimize their impact on the established properties of the functional layers of the MLM structure. The material 120 may thus comprise a modified interface portion of the Si layer 110, rather than a completely separate layer. This modification to reduce conductivity can alternatively be achieved by doping in the silicon layers surrounding the metal layer, or by chemical modification of the metal layer itself

The results of such a modification have been modeled by computation, with results shown in FIG. 6. By modeling reflection of EUV and IR wavelengths with all conduction electrons active, the traces EUV R and IR R1 show the reflection coefficient (vertical axis) variation with a for a simulated MLM structure. Modifying the model to incorporate the effects of the modification of FIG. 5, in which only, for example, half the conduction electrons are participating, the trace IR R2 results. This shows the potential to reduce markedly the IR reflectivity, as curve IR R2 allows the design parameter a to be increased well beyond 0.3 to improve EUV reflectivity above 70%, without incurring a severe penalty in increased IR reflectivity.

The provision of modifying material 120 either side of the metal layer 112 is only one possible configuration. Material 120 can be mixed through the metal layer, or a central layer dividing two or more sub-layers.

### Metal Layer Splitting

FIG. 7 illustrates another way to suppress infrared reflection from metal layers 112 in MLM 100. The structure 106 is the conventional layer pair 110, 112 described above, with period h. Structure 106′ includes the modified layer pair in which the metal layer 112 has been split into two parts 112a, 112b by the insertion of a thin insulating barrier 140. This may be for example B₄C, Si₃N₄, or other materials which can conveniently and compatibly be deposited between layers of Mo or other metal used. Another modified layer pair is shown at structure 106″, in which two barrier layers are provided, splitting the metal layer into three distinct components.

Modeling shows that splitting of the metal (Mo) layer 112 into sub-layers by very thin insulator barriers won't deteriorate significantly the EUV reflectivity of MLM 100. However, for IR wavelengths, optical constants of the Mo sub-layers will be different from these of undivided Mo layer. Notably, the permittivity ε of sub-layers will be lower than the permittivity of thick

Mo layer. Results of calculation for Si/Mo mirrors with structures 106, 106′ and 106″ on Si substrate are shown in the Table 2 below (N=400 as before).

TABLE 2

| | Period Structure | | | | | |
|---|---|---|---|---|---|---|
| | 106 | | 106′ | | 106″ | |
| Period h | 6.9 | nm | 6.9 | nm | 6.9 | nm |
| Mo | 1 * 2.76 | nm | 2.56 = 2 * 1.28 | nm | 2.34 = 3 * 0.78 | nm |
| B₄C | 0.0 | nm | 0.20 = 1 * 0.2 | nm | 0.40 = 2 * 0.2 | nm |
| Si | 4.14 | nm | 4.14 | nm | 4.14 | nm |

| | | | |
|---|---|---|---|
| EUV R max | 0.729 | 0.722 | 0.707 |
| IR R | 0.827 | 0.612 | 0.372 |

As can be seen, splitting the metal layer allows EUV R to remain reasonably constant and above 70%, while IR R is cut significantly, from over 80% to under 40%. Splitting into more than three sub-layers, splitting into non-equal sub-layers and so forth are all possible, although a simpler structure is easier to control and cheaper of course to manufacture.

In an embodiment, structure 106′ may be used exclusively, or structure 106″. More splitting could be envisaged, and unmodified layer pairs 106 could also be included in parts of the stack. Different structures can be interleaved throughout the stack, or applied in distinct regions of the stack. Parameters can be varied on a graded basis both vertically and in the plane of the mirror. The conductivity of the metal in the sub-layers can be modified, as discussed with reference to FIGS. 5 and 6. These measures can be applied in addition to the various measures for controlling reflectivity as a function of bandwidth, incidence angle and so forth that are discussed above as coming from the prior art.

### Role of Substrate

An MLM 100 with low a is expected to be transparent enough to allow infrared radiation reach the substrate 108 or more accurately to any metal or other special layer 114 located at the front or rear of the substrate 108. Thus IR reflection of MLM 100 as a whole becomes sensitive to its substrate or rear layers. A substrate (or thick substrate layer 114) with appropriate refractive index can reflect substantially all the IR radiation which reaches it. By careful design this reflected component can produce destructive interference with the beams reflected from the interfaces higher in the stack, similar to the behavior of a quarter wave anti-reflection coating. The conventional MLM structures are too thin and too reflective in relation to the long IR wavelengths to benefit from this effect. The results presented below indicate that with simple optimization of the parameters, it should be possible to obtain very deep suppression of IR reflectivity in an MLM made according to embodiments of the invention. Quantitatively, the effect of suppression depends on the thickness of metal substrate and on material of the substrate. Good results can be achieved with Mo layer 114 about 20 nm or larger. The substrate layer need not be of the same metal, however.

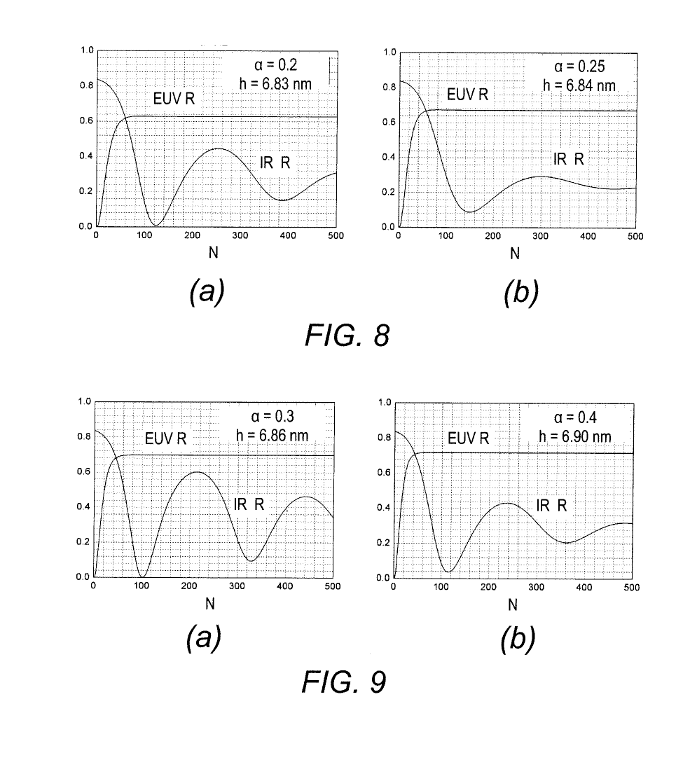

FIGS. 8(a) and (b) present calculated performance of Si/Mo MLM with split Mo layers as discussed above, as a function of N. Number of periods N was varied from 1 to 500. Calculations were made for a Mo/Si MLM on a 20 nm Mo substrate layer 114 with each Mo layer 112 split into two sub-layers 112a, 112b with B₄C barriers 140 (structure 106′ in FIG. 7). The period h was (a) 6.83 nm and (b) 6.84 nm.

FIGS. 9(a) and (b) present similar results for MLMs with periods (a) 6.86 nm and (b) 6.90 nm, with each Mo layer 112 split into three sub-layers (structure 106″) and additional (chemical) reduction of Mo conductivity 2 times (β=0.25), and a 20 nm Mo film 114 on substrate.

As can be seen, the examples of Si/Mo MLMs presented on FIGS. 8 and 9 have a deep minimum of IR reflection at a number of periods about 100, while EUV reflection saturated at 40-60 periods. Low reflection coefficient near this minimum of IR reflectivity may be caused by absorption of radiation in thin Mo layers and destructive interference of partial reflected waves. Whatever the underlying mechanisms, it is a matter of routine experimentation to arrive at the optimum configuration for a given application, based on the modeled results. To maximize the performance lifetime of the mirror in a hostile environment, the number of layers initially could be slightly greater than the optimum (for example at N=110 on the graph of FIG. 8(a)), so that performance does not immediately deteriorate when the front surface layers are eroded. Even away from optimum performance, the element performs better than known SPF designs in selecting the wanted from the unwanted radiation.

### Conclusion & Advantages of Novel MLM

The proposed solution, either combining all the measures introduced above or only a subset of them, allows the problem of unwanted long-wavelength IR to be addressed very strongly, yet without the addition of new elements into the machine, because multilayer mirrors are already part of it. In such a solution there is potentially no problem with cooling unlike in proposed types of SPF.

As mentioned already, a number of different measures can be combined in a practical embodiment, including measures introduced here for the first time, and measures known from the prior art. A typical MLM, for example, could consist of multilayer stack with Mo/Si ratio α of 0.1-0.4, for example, with a ratio of 0.2 at which 10.6 μm radiation suppression is about factor of 3 while EUV reflection is 0.85. An optimized version of MLM 100 would include a depth graded a parameter that would allow for maximum of EUV reflectance and maximum IR suppression.

The example values and performance calculations presented above are based on the example of 13.6 nm EUV wavelength and 10.6 μm IR wavelength, and normal incidence reflection. The skilled reader will readily appreciate how the preferred dimensions and choice of material will change as angle of incidence and wavelengths vary. With a period h in the range 6.8-7.0 nm and a number of layers approximately 100-110, it is easily calculated that the overall thickness H of the stack will be in the range 650-800 nm. By contrast, known MLM for EUV radiation of this wavelength might have fewer than 70 layers, for example only 40-60 layers, and a thickness (for normal incidence) less than 600 nm, for example, less than 500 nm. To assess whether a structure fulfils the dimensions of a quarter-wave (anti-reflective) or half-wave (reflective) layer, the path length of a ray should be multiplied by the refractive index of the layer pair, to obtain the optical path length for comparison with the radiation wavelengths. Periods in the range 0.5-0.7 times the EUV wavelength may be regarded as suitable.

### Manufacturing Method

One method to apply a metal coating on the substrate is by atomic layer deposition (ALD). ALD uses alternating steps of a self-limiting surface reaction to deposit atomic layers one by one. The material to be deposited is provided through a precursor. ALD methods are known for several metals, for example, Mo, Ti, Ru, Pd, Ir, Pt, Rh, Co, Cu, Fe and Ni. Instead of ALD, galvanic growth (electrodeposition) may be used to deposit the metal, or it can also be deposited for example by evaporation or sputter deposition. Examples of such methods are given in the prior art references, mentioned in the introduction.

These processes may be used alone or in combination with one another.

Although several different metals may be used, molybdenum is an attractive candidate because of its high melting point and proven vacuum compatibility. Other materials can be chosen for their distinctive properties, however, particularly where a different wavelength of wanted and/or unwanted radiation is involved.

It will be understood that the apparatus of FIGS. 1 and 2 incorporating one or more reflecting elements with the modified multi-layer structures described above may be used in a lithographic manufacturing process. Such lithographic apparatus may be used in the manufacture of ICs, integrated optical systems, guidance and detection patterns for magnetic domain memories, flat-panel displays, liquid crystal displays (LCDs), thin-film magnetic heads, etc. It should be appreciated that, in the context of such alternative applications, any use of the term “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

It will be appreciated that embodiments of the invention may be used for any type of EUV source, including but not limited to a discharge produced plasma source (DPP source), or a laser produced plasma source (LPP source). However, an embodiment of the invention may be particularly suited to suppress radiation from a laser source, which typically forms part of a laser produced plasma source. This is because such a plasma source often outputs secondary radiation arising from the laser.

The novel reflecting elements may be located practically anywhere in the radiation path. In an embodiment, the novel multilayer structure is applied in the first reflecting surface that receive EUV-containing radiation from the EUV radiation source and delivers the EUV radiation to a suitable downstream EUV radiation optical system, namely the collector. Alternatively or in addition, the novel multilayer element is applied in one or more mirrors in the projection system.

While specific embodiments of the present invention have been described above, it should be appreciated that the present invention may be practised otherwise than as described.

1. A multilayer mirror configured to reflect extreme ultraviolet (EUV) radiation while absorbing radiation of a second type having a wavelength substantially longer than that of the EUV radiation, the minor comprising:
a plurality of layer pairs stacked on a substrate, each layer pair comprising a first layer comprising a first material and a second layer comprising a second material, wherein the first layer in at least a subset of the layer pairs is modified to reduce its contribution to reflection of said second radiation, compared with a simple layer of the first material having the same thickness.

2. A mirror as claimed in claim 1, wherein the modified first layers comprise said first material adjacent to or mixed with a third material which is effective to reduce the availability of conduction electrons in said first material.

3. A minor as claimed in claim 1, wherein each of said modified first layers comprises said first material in a plurality of sub-layers divided from one another by barrier layers of relatively insulating fourth material.

4. A minor as claimed in claim 3, wherein at least a subset of said sub-layers comprise said first adjacent or mixed with a third material effective to reduce the availability of conduction electrons in said first material.

5. A mirror as claimed in claim 1, wherein said first material is a metal and said second material is a semiconductor.

6. A mirror as claimed in claim 1, wherein the thickness of each layer pair in a substantial portion of said stack is in the range 5-7 nm.

7. A mirror as claimed in claim 6, wherein the thickness of each layer pair in a substantial portion of said stack is in the range 6.5-7 nm.

8. A mirror as claimed in claim 1, wherein the total thickness of said plurality of layer pairs is greater than 500 nm.

9. A mirror as claimed in claim 1, wherein said stack is formed on top of a substrate layer, the substrate layer comprising a layer of said first material 5 or more times thicker than said first type of layer in the layer pairs of the stack, wherein said substrate layer is configured to reflect back into the stack substantially all of second radiation that reaches the substrate layer.

10. A lithographic apparatus comprising:
a radiation source configured to generate radiation comprising extreme ultraviolet (EUV) radiation;
an illumination system configured to condition the radiation into a beam of radiation; a support configured to support a patterning device, the patterning device being configured to pattern the beam of radiation; and
a projection system configured to project a patterned beam of radiation onto a target material;
wherein at least one of said radiation source, said illumination system and said projection system includes a multilayer mirror configured to reflect the EUV radiation while absorbing radiation of a second type having a wavelength substantially longer than that of the EUV radiation, the mirror comprising a plurality of layer pairs stacked on a substrate, each layer pair comprising a first layer comprising a first material and a second layer comprising a second material, wherein the first layer in at least a subset of the layer pairs is modified to reduce its contribution to reflection of said second radiation, compared with a simple layer of the first material having the same thickness.

11. An apparatus according to claim 10, wherein said radiation source comprises a fuel delivery system and laser radiation source, the laser radiation source being arranged to deliver radiation at infrared wavelength onto a target comprising plasma fuel material delivered by said fuel delivery system for the generation of said extreme ultraviolet radiation, the radiation source thereby emitting a mixture of extreme ultraviolet (EUV) and infrared radiation toward said multilayer mirror, the multilayer mirror having a reflectivity greater than 60% for said EUV radiation and having reflectivity less than 40% for said infrared radiation.

12. An apparatus according to claim 10, wherein said multilayer mirror is the first reflective element encountered by the generated EUV radiation.

13. A method for manufacturing a multilayer mirror configured to transmit extreme ultraviolet radiation, the method comprising:
depositing alternately first and second types of layers to form a stack of layer pairs on a substrate, wherein each layer pair comprises a first layer comprising at least a first material and a second layer comprising at least a second material, and wherein the first layer in at least a subset of the layer pairs is formed so as to reduce its contribution to reflection of said second radiation, compared with a simple layer of the first material having the same thickness.

14. A method as claimed in claim 13, wherein in said subset of layer pairs the first layer is formed adjacent to or mixed with a third material which is effective to reduce the availability of conduction electrons in said first material.

15. A method as claimed in claim 13, wherein in said subset of layer pairs the first layer is formed by a plurality of sub-layers of said first material, divided from one another by barrier layers of relatively insulating fourth material.
